(19) United States
(12) Patent Application Publication
(10) Pub. No.: US 2011/0075842 A1
(43) Pub. Date: Mar. 31, 2011

(54) Method and System Making It Possible to Visually Encrypt the Mobile Objects Within A Compressed Video Stream

(75) Inventors: Cédric Le Barz, Limours En Hurepoix (FR); Marc Leny, Nanterre (FR); Erwann Renan, Paris (FR)

(73) Assignee: THALES, Neuilly-sur-Seine (FR)

(21) Appl. No.: 12/996,148

(22) PCT Filed: Jun. 3, 2009
(86) PCT No.: PCT/EP09/56830

§ 371 Date: Dec. 3, 2010

(30) Foreign Application Priority Data
Jun. 3, 2008 (FR) 08 03063

(51) Int. Cl. H04N 7/167

(52) U.S. Cl. 380/212

(57) ABSTRACT

A method and system is provided of protecting at least one part of a video stream or of a compressed video sequence against a violation of the information contained in said stream, said stream being able to be broken down into at least one first type of objects and one second type of objects, the method being applied to a selection of images contained in said video sequence, characterized in that it comprises at least the following steps: analyzing the video sequence in the compressed domain so as to define for a given image N at least one first type of objects to be protected by encryption and one second type of objects, the analysis module which identifies the portions of the image belonging to the first type of objects to be protected sends the motion estimation vectors and the transformed coefficients to the encryption step; determining, according to the breakdown into portions or into groups of portions of the existing image N, those corresponding respectively to the first type of objects to be protected and to the other types; encrypting at least a part of the first type of objects; reconstructing, on the basis of the outputs of the preceding steps, a stream consisting of at least one first type of encrypted objects and other types of objects, to which is added information indicating which objects are the ones that have been encrypted.

The invention relates to a method and a system for transmitting a compressed video stream while providing a visual encryption of the moving objects. The method incorporates an encryption step for selected areas in a given image of the compressed stream. The invention is applied for transmitting compressed video streams in a transmission context where the latter are likely to be intercepted and viewed. It is also used to avoid any access to the content of certain protected areas in the image. Thus, any malicious viewing of the screen can be avoided. It in fact makes it possible to protect, for example, the private life of the persons in places equipped with video surveillance, by allowing for a partial or total decoding of the image according to an accreditation level or a particular authorization.

Hereinafter in the description, the term “foreground” designates the moving object(s) in a video sequence, for example, a pedestrian, a vehicle, a molecule in medical imaging. On the other hand, the designation “background” is used with reference to the environment and to the fixed objects. This corresponds, for example, to the ground, buildings, trees that are not perfectly immobile or even stationary cars. More generally, it is possible in an image to define several areas that are processed differently according to the degree of confidentiality that must be associated therewith.

The words encryption or ciphering are used interchangeably.

The invention is applied, for example, at the output of a video coder. The invention can, among other things, be applied in applications implementing the standard jointly defined by the ISO, MPEG and the ITU-T video coding group called H.264 or MPEG-4 AVC (advanced video coding) and SVC (scalable video coding) which is a video standard that provides a more effective compression than the previous video standards while offering an implementation complexity that is reasonable and geared toward networked applications.

Hereinafter in the description, the applicant uses the expression “compressed stream” or “compressed video sequence” to designate one and the same object.

The expression “slices” or “portions”, better known in the field by the expression “slices”, corresponds to a subpart of the image consisting of macroblocs which belong to one and the same set defined by the user. These terms are well known to those skilled in the art in the field of compression, for example, in the MPEG standards.

The concept of network abstraction layer, or NAL, used hereinafter in the description exists in the H.264 standard. It is a network transport unit which can contain either a portion or “slice” for the VCL (video coding layer) NALs, or a data packet (set of parameters known to those skilled in the art—SPS, PPS-, user data, etc.) for the non-VCL NALs.

Video surveillance is increasingly being used, often raising the issue of respect for private life. In some applications, only images or areas of images or video streams must be able to be accessible, the accessibility being associated with authorized people.

The publication entitled Compliant Selective encryption for H.264/AVC video streams by Cyril Bergeron and Catherine Lamy (Proceedings of the International Workshop on Multimedia Processing, MMSP'05, Shangai) discloses a method that makes it possible to encrypt a video stream so as to secure the transmission of the information contained in this stream while preserving compatibility with the H.264 standard. If only a few bits within the stream are modified to obtain this result, the video sequence produced is visually totally encrypted, and cannot be viewed without a decoding key.

One of the objects of the present invention is to offer a method of protecting the content of images or of certain areas of an image capable of targeting only the mobile objects within a compressed video stream in order to preserve the integrity of the data and their confidentiality.

The invention relates to a method of protecting at least one part of a video stream or of a compressed video sequence against a violation of the information contained in said stream, said stream being able to be broken down into at least one first type of objects and one second type of objects, the method being applied to a selection of images contained in said video sequence, characterized in that it comprises at least the following steps:
a) analyzing the video sequence in the compressed domain so as to define for a given image N at least one first type of objects to be protected by encryption and a second type of objects,
b) determining, according to the breakdown into portions or into groups of portions of the existing image N, those corresponding respectively to the first type of objects to be protected and to the other types,
c) encrypting at least a part of the first type of objects, and
d) reconstructing, on the basis of the outputs of the preceding steps, a stream consisting of at least one first type of encrypted objects, and of other types of objects, to which is added information indicating which objects are the ones that have been encrypted.

The invention also relates to a method of protecting a video stream compressed with an H.264 standard, characterized in that it includes, during the step c), at least the following steps:
analyzing the video stream in the compressed domain,
defining at least one first group of objects containing areas or objects to be encrypted in said stream, and identifying the portions of the image containing them,
encrypting the portions identified by the preceding step,
for a given image or a given group of images, creating a network transport unit of “undefined NAL” type, which will convey the identification of the encrypted image portions,
reconstructing a single compressed stream comprising encrypted and unencrypted areas, and the new NAL units identifying the image portions that have been encrypted.

The first group of objects corresponds, for example, to a foreground comprising moving objects in an image.

It may use an encryption method that makes it possible to modify, within slice groups corresponding to the foreground, the bits that allow for decoding with a standard decoder.

It uses, for example, an encryption method that makes it possible to modify, within slice groups corresponding to the foreground, the bits that will allow a total decoding in the event of use of the encryption or ciphering key.

The method uses, for example, a function suitable for determining a mask for identifying blocks of an image or group of images comprising one or more mobile objects defined as one or more regions of the mask and the other blocks belonging to the background following an analysis in the compressed domain.

The video sequence being produced by an MPEG-4 part 10/H.264 standard, the method for defining the portions or “slice groups” uses, for example, the flexible microbloc ordering or FMO technique allowing for the definition of the slice groups macrobloc by macrobloc.

The invention also relates to a system that makes it possible to visually encrypt a video sequence, characterized in that it comprises at least one video processing unit suitable for executing the steps of the method described previously comprising at least the following elements:
a means suitable for identifying the portions of the video sequence that will be encrypted,
a module for encrypting the identified portions,
a buffer memory which receives the other parts of the stream that are not encrypted,
a module suitable for merging the part of the compressed encrypted stream and the part of the unencrypted and compressed stream,
said identification and visual encryption modules communicating with one another.

Other features and advantages of the device according to the invention will become more apparent from reading the following description of an exemplary embodiment given as an illustrative and non-limiting example, with appended figures which represent:

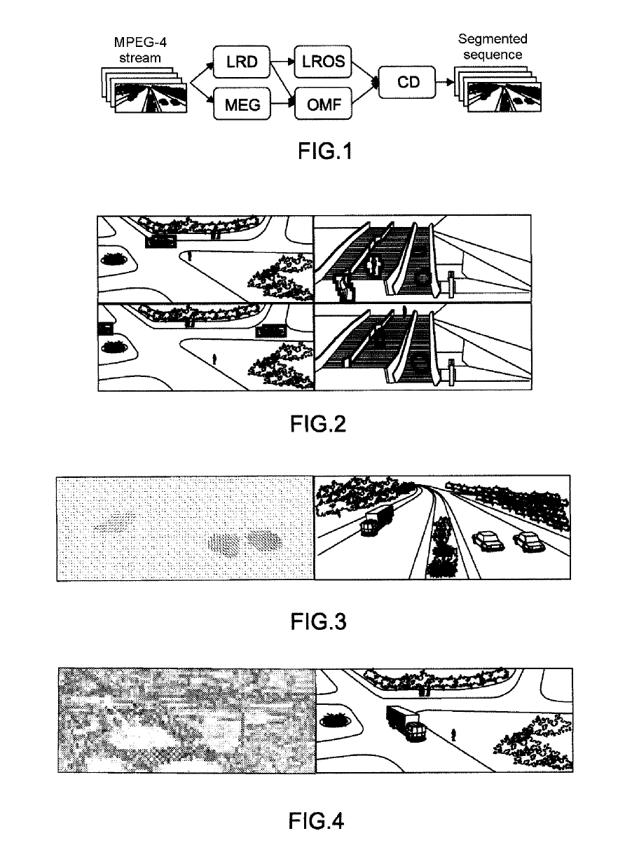

FIGS. 1 to 4, the results obtained by an analysis in the compressed domain,

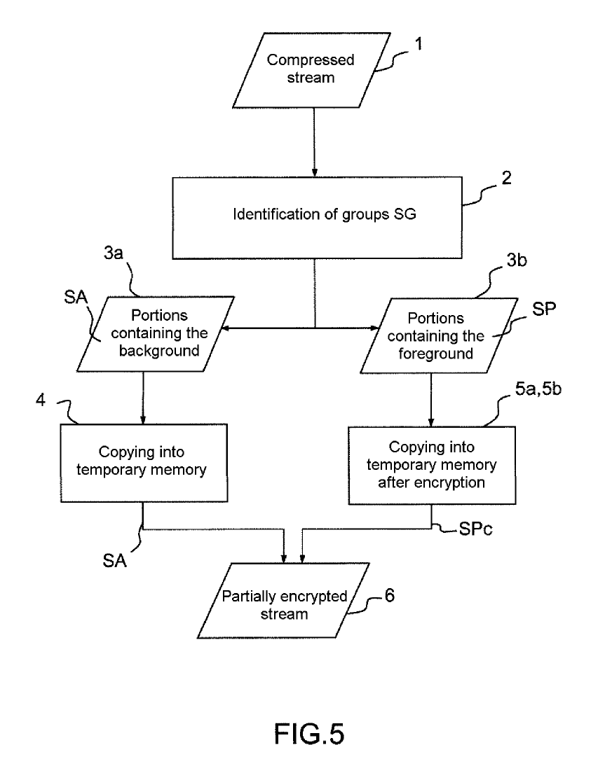

FIG. 5, an example describing the steps implemented to add a visual encryption to the compressed stream, and

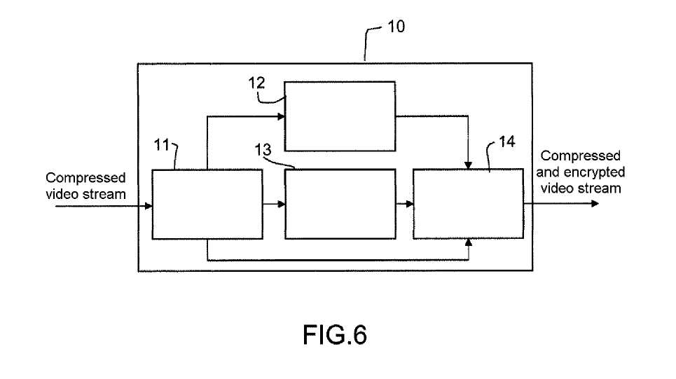

FIG. 6, an exemplary diagram for a video unit according to the invention.

In order to better understand the operation of the method according to the invention, the description includes a review of how to perform an analysis in the compressed domain, as is described for example in patent application US 2006 188013 with reference to FIGS. 1, 2, 3 and 4 and also in the following two references:
Leny, Nicholson, Prêteux, “De l'estimation de mouvement pour l'analyse temps réel de vidéos dans le domaine compressé”, GRETSI, 2007.
Leny, Prêteux, Nicholson, “Statistical motion vector analysis for object tracking in compressed video streams”, SPIE Electronic Imaging, San Jose, 2008.

To sum up, the techniques used among other things in the MPEG standards and explained in these articles consist in dividing the video compression into two steps. The first step aims to compress a fixed image. The image is divided into blocks of pixels (4×4 or 8×8 according to the MPEG-1/2/4 standards), which then undergo a transformation allowing for a transition to the frequency domain, then a quantization makes it possible to approximate or eliminate the high frequencies to which the eye is less sensitive. Finally, these quantized data are entropically encoded. The objective of the second step is to reduce time redundancy. To this end, it can be used to predict an image on the basis of one or more other images previously decoded within the same sequence (motion prediction). For this, the process searches in these reference images for the block that best corresponds to the desired prediction. Only a vector (motion estimation vector, or motion vector), corresponding to the movement of the block between the two images, and a residual error that can be used to refine the visual rendition are retained.

These vectors do not, however, necessarily correspond to an actual motion of an object in the video sequence but may be like noise. Various steps are therefore needed to use such information in order to identify the mobile objects. The works described in the abovementioned publication Leny et al, “De l'estimation de mouvement pour l'analyse temps reél de vidéos dans le domaine compressé”, and in the abovementioned US patent application, have made it possible to delimit five functions making analysis in the compressed domain possible, these functions and the implementation means corresponding to them being represented in FIG. 1:

1) a low resolution decoder (LRD) is used to reconstruct all of a sequence at the resolution of the block, eliminating at this scale the motion prediction;
2) a motion estimation generator (MEG) determines vectors for all the blocks that the coder has coded in “intra” mode (within intra or predicted images);
3) a low-resolution object segmentation module (LROS) is, for its part, based on an estimation of the background in the compressed domain by virtue of the sequences reconstructed by the LRD and therefore gives a first estimation of the mobile objects;
4) the filtering of objects based on motion (OMF—Object Motion Filtering) uses the vectors output from the MEG to determine the mobile areas based on the motion estimation;
5) finally, a cooperative decision module (CD) can be used to establish the final result from these two segmentations, taking into account the specifics of each module according to the type of image analyzed (intra or predicted).

The main benefit of analysis in the compressed domain relates to the computation times and the memory requirements which are considerably reduced compared to the conventional analysis tools. By relying on the work performed at the time of video compression, the analysis times are now 10 to 20 times real time (250 to 500 images processed per second) for 4:2:0 720×576 images

One of the drawbacks in analysis in the compressed domain as described in the abovementioned documents is that the work is carried out on the equivalent of low-resolution images by manipulating blocks consisting of groups of pixels. The result is that the image is analyzed with less accuracy than by implementing the usual algorithms used in the uncompressed domain. Furthermore, those objects that are too small in relation to the breakdown into blocks may go unnoticed.

The results obtained by analysis in the compressed domain are illustrated by FIG. 2, the results showing the identification of areas containing mobile objects. FIG. 3 diagrammatically represents the extraction of specific data such as the motion estimation vectors and FIG. 4 low-resolution confidence maps obtained that correspond to the contours of the image.

FIG. 5 diagrammatically represents an exemplary implementation of the method according to the invention during which areas of an image contained in a compressed video stream will be visually encrypted. This step, performed by encryption of certain bits by using, for example, the method described in the abovementioned article by Bergeron et al, will be executed on the compressed video stream. Certain areas in the image that have a higher level of confidentiality will be selected and be encrypted so as to avoid direct access to the data that they contain.

The compressed video stream 1 at the output of a coder is transmitted to a first analysis step 2, the function of which is to identify the mobile objects. Thus, the method generates a sequence of masks comprising regions that have received an identical label, or blocks linked to the mobile objects.

This analysis in the compressed domain has made it possible to define for each image or for a defined group of images GoP, on the one hand different areas Z1i belonging to the foreground P1 and other areas Z2i belonging to the background P2 of a video image. The analysis can be done by implementing the method described in the abovementioned US patent application. However, any method that makes it possible to obtain an output from the analysis step in the form of masks for each image, or any other format or parameters associated with the analyzed compressed video sequence can also be implemented instead of the proposed analysis step in the compressed domain. On completion of the analysis step, the method has, for example, binary masks for each image (block or macrobloc resolution). An exemplary convention used may be as follows: “1” corresponds to a block of the image belonging to the foreground and “0” corresponds to a block of the image belonging to the background. From these masks, the groups of portions of the image, better known as “slice groups”, which comprise one or more blocks identified as belonging to the foreground are selected with a view to the encryption step. This corresponds to step 2 in FIG. 5, the results being the identified slice groups (3a and 3b). The image is thus segmented according to its semantic content.

In a more general application context, it will be possible to define not two areas, but several types of objects which will give rise to a visual encryption application according to their importance and their sensitivity, for example by the use of different keys.

According to a variant implementation as indicated previously, it is also possible to process the boxes surrounding mobile objects. The coordinates of surrounding boxes correspond to the mobile objects and are computed using the mask. These boxes can be defined by two extreme points, by a central point associated with the dimension of the box, and so on. There may also be a set of coordinates for each image or a set for all of the sequence with trajectory information (date and point of entry, curve described, date and point of exit). A search will then be made for the slices of the image that are at least partially covered by one of the surrounding boxes corresponding to the foreground. The masks may be binary masks.

The portions of the image 3a that do not require visual ciphering or encryption are simply copied into the temporary buffer memory 4.

On the other hand, the method processes, 5a and 5b, the areas of the image that include these mobile objects in order to visually encrypt them by means of an encryption key for example. The encrypted and unencrypted parts are then merged, 6. Information indicating the parts of the stream that have been encrypted are added so as to differentiate them in the decoder. This addition is made by using techniques known to those skilled in the art. In this exemplary implementation, the encryption or ciphering step applies, to the slice groups identified in the step 2, the method described in the article by Bergeron et al or in the patent application WO 2006/067172. Since the latter is designed to encrypt the data of a compressed stream, the visual encryption can be done directly within the compressed stream without involving steps other than the stream interpretation step, or parsing step, which is already performed prior to the analysis in the compressed domain. This makes it possible to obtain results with very low computation time and memory resources.

In the case of the H.264 standard, an NAL, of undefined type 30 or 31 within which it is possible to transmit any type of information, will receive the identification of the groups of portions that have been visually encrypted. Unlike the other NAL types, the NALs 30 and 31 are not reserved, whether for the stream itself or the RTP-RTSP-type network protocols. A standard decoder will simply discard this information whereas a specific decoder, developed to take account of this type of NALs, can choose to use this information to detect and possibly decrypt the protected areas.

In the case of a stream that has been encoded according to recommendations present in the applicant's patent application filed on the same day and entitled “Construction d'une nouvelle structure image s'appuyant sur des objets sémantiques au sein d'un flux vidêo compressé et le dispositif associé” (Construction of a new image structure based on semantic objects within a compressed video stream and associated device), the nature of the objects or groups of objects (encrypted or not) may be directly included in the corresponding header. This new structure relies on a hierarchical organization of the image into: image, image group or images, portions or “slices”.

The two buffer memories 4, 5b containing the encrypted and unencrypted parts of the streams are then merged, accompanied by the determined NALs, to reconstruct a single stream 6 which is now visually partially encrypted.

It should be noted that the encryption method used preserves the structure of the stream from the various headers to the possibility of decoding the data via the variable length coding (VLC) present in the H.264 standard. Thus, a conventional decoder will therefore consider a stream to be normal, without encryption features, and therefore supply a decoded sequence having a part of the image without specifics (by default, the background) and another part encrypted (the groups of portions or “slices” comprising the mobile objects). By comparison, a specific decoder will identify the “undefined NAL” comprising the identification of the groups of portions that have been encrypted. The decryption key will allow for a viewing of the sequence that is totally intelligible. This makes it possible, for example, in the context of video surveillance, to transmit the encrypted stream to the guard post where security operatives can identify the presence of a person, of a car, of a truck, etc., through silhouettes, without being able to directly identify the face of the person or the registration plate of the vehicle, which can be viewed by a security manager, police services, etc. This characteristic allows for a wider distribution of the surveillance streams while respecting constraints associated with private life.

This method is implemented within a video processing unit schematically represented in FIG. 6.

The processing unit 10 comprises a tool for detecting portions of the video stream or of the image to be encrypted 11 suitable for determining various areas of interest of the image, that is to say, the areas of the image that must be encrypted. The unit 10 includes a module 13 for encrypting the identified portions, and a buffer memory 12 which receives the part of the encrypted stream together with the unencrypted other parts of the stream in a partially encrypted stream and another module 14 that makes it possible to merge the two parts of the stream, the encrypted and compressed part and the unencrypted and compressed part.

Two apparently independent main steps constitute the present invention: analysis and visual encryption. Physically, these various modules can communicate with one another to optimize all of the processing chain:
For the analysis in the compressed domain, it is necessary to deencapsulate the stream, to format the data (parse it) and finally to perform an entropic decoding. The motion estimation vectors and the transformed coefficients are thus obtained. These modules are also necessary for the encryption but will not have to be reiterated.
The analysis module which identifies the portions of the image that belong to the regions of interest sends these parameters to the encryption block accompanied by the previously obtained data.
For the actual visual encryption part, once again the transformed coefficients and motion estimation vectors are necessary. The proposed method here makes it possible also to do away with the deencapsulation and entropic decoding step since the information circulates from module to module.
Once these steps are processed, only the new entropic encoding (which may physically commence during encryption) and the encapsulation of the stream then take place.

The invention therefore allows for more than a simple juxtaposition of functions processing a video stream in series: feedback loops are possible and all the redundant steps between the modules involved are no longer present only once.

Breakdown into portions and groups of portions is not managed by the method, which must apply the proposed processing operations to the partition of the image that exists within the compressed video stream 1. Then, the results may vary depending on the type of standard and coder used when compressing the sequence. If the image is, for example, simply vertically divided into three portions, the method will then encrypt one, two or even three thirds of the image. Although the method works in this case, the results resulting therefrom are of little interest. On the other hand, with an encoder implementing H.264 within which a slice group is assigned to each mobile object, the results correspond to an encryption of only the mobile objects, even allowing for an identification of the type of object by its shape and contour (car, pedestrian, etc.). For example, a video stream that has a structure as described in the applicant's patent application filed on the same day as the present application and entitled “Construction d'une nouvelle structure image s'appuyant sur des objets sémantiques au sein d'un flux video compressé et le dispositif associé” (Construction of a new image structure based on semantic objects within a compressed video stream and associated device) makes it possible to obtain optimal results. The independent reconstruction of the objects then ensures a visual encryption closest to the object, impacting on the intelligibility of the rest of the scene.

Without departing from the context of the invention, other techniques will make it possible to encrypt areas in an image in order to ensure that the confidentiality of the information that they contain may be used, provided that they do not compromise the fact that the stream may be decoded by an implantation according to the standard concerned.

This operation can also be effected in parallel with a target bit rate order for the mobile objects in the sequence. It will then be possible to add robustness to the errors (which increases the bit rates) coupled to an adaptation to a target bit rate by on-the-fly optimization on the already compressed stream. This coupling will make it possible, for example, to maintain a fixed bit rate while protecting the content linked to the foreground.

1. A method of protecting at least one part of a video stream or of a compressed video sequence against a violation of the information contained in said video stream or in said compressed video sequence, said video stream or said compressed video sequence being able to be broken down into at least one first type of objects and one second type of objects, the method being applied to a selection of images contained in said video sequence, comprising at least the following steps:
a) analyzing the video sequence in the compressed domain so as to define for a given image N at least one first type of objects to be protected by encryption and a second type of objects, said analysis module identifies the portions of the image belonging to the first type of objects to be protected, and extracts from the video stream, the motion estimation vectors and the transformed coefficients associated with the first type of objects and transmits said parameters to the step c),
b) determining, according to the breakdown resulting from the analysis into portions or into groups of portions of the existing image N, those corresponding respectively to the first type of objects to be protected and to the other types,
c) encrypting at least a part of the first type of objects by encrypting the motion estimation vectors and the transformed coefficients, and
d) reconstructing, on the basis of the outputs of the preceding steps, a stream consisting of at least one first type of encrypted objects and of other types of objects, to which are added information indicating which objects are the ones that have been encrypted.

2. The method as claimed in claim 1 for a stream compressed with an H.264 standard, further comprising, during the step c, at least the following steps:
analyzing the video stream in the compressed domain,
defining at least one first group of objects containing areas or objects to be encrypted in said stream, and identifying the portions of the image containing them,
encrypting the portions identified by the preceding step,
for a given image or a given group of images, creating a network transport unit of “undefined NAL” type, which will convey the identification of the encrypted image portions,
reconstructing a single compressed stream comprising encrypted and unencrypted areas, and the new NAL units identifying the image portions that have been encrypted.

3. The method as claimed in claim 1, wherein the first group of objects corresponds to a foreground comprising moving objects in an image.

4. The method as claimed in claim 3, wherein it uses an encryption method that makes it possible to modify, within slice groups corresponding to the foreground, the bits that allow for decoding with a standard decoder.

5. The method as claimed in claim 4, wherein it uses an encryption method that makes it possible to modify, within slice groups corresponding to the foreground, the bits that will allow the total decoding in the event of use of the encryption or ciphering key.

6. The method as claimed in claim 1, wherein it uses a function suitable for determining a mass for identifying blocks of an image or group of images comprising one or more mobile objects defined as one or more regions of the mask and the other blocks belonging to the background following an analysis in the compressed domain.

7. The method as claimed in claim 1, wherein, the video sequence being produced by an MPEG-4 part 10/H.264 standard, the method for defining the portions or “slice groups” uses the flexible macrobloc ordering or FMO technique allowing for the definition of the slide groups macrobloc by macrobloc.

8. A system that makes it possible to visually encrypt a video sequence, comprising at least one video processing unit suitable for executing the steps of the method as claimed in claim 1 and further comprising at least the following elements:
a means suitable for identifying the portions of the video sequence that will be encrypted,
a module for encrypting the identified portions,
a buffer memory which receives the other parts of the stream that are not encrypted,
a module suitable for merging the part of the compressed encrypted stream and the part of the unencrypted and compressed stream,
said identification and visual encryption modules communicating with one another.

9. The method as claimed in claim 2 wherein the first group of objects corresponds to a foreground comprising moving objects in an image.

10. The method as claimed in claim 2 wherein it uses a function suitable for identifying blocks of an image or group of images comprising one or more mobile objects defined as one for more mobile objects defined as one or more regions of the mask and the other blocks belonging to the background following an analysis in the compressed domain

11. A system that makes it possible to visually encrypt a video sequence, comprising at least one video processing unit suitable for executing the steps of the method as claim in claim 2.
